(19) United States
(12) Patent Application Publication
(10) Pub. No.: US 2025/0101619 A1
(43) Pub. Date: Mar. 27, 2025

(54) AN ALKALINE HIGH-PRESSURE ELECTROLYZER

(71) Applicant: HYDROGENPRO ASA, Porsgrunn (NO)

(72) Inventor: Richard ESPESETH, Porsgrunn (NO)

(21) Appl. No.: 18/722,815

(22) PCT Filed: Dec. 22, 2022
(86) PCT No.: PCT/EP2022/087587

§ 371 Date: Jun. 21, 2024

(30) Foreign Application Priority Data
Dec. 22, 2021 (NO) 20211575

(51) Int. Cl. C25B 15/06; C25B 1/04; C25B 9/05; C25B 9/23; C25B 9/75; C25B 9/77

(52) U.S. Cl. CPC C25B 15/06; C25B 1/04; C25B 9/05; C25B 9/23; C25B 9/75; C25B 9/77

(57) ABSTRACT

It is described a high-pressure alkaline electrolyzer for splitting water into hydrogen and oxygen, said electrolyzer comprising a stack of electrolysis cells (1), with channels supplying lye to the cathodes and anodes and channels conducting hydrogen from the cathodes and oxygen from the anodes. The electrolyzer includes first and second lye inlet channels (4a, 4b), a multitude of first intermediate lye channels (5a) conducting lye from the first lye inlet channel (4a) to each cathode (3a) in the stack, a multitude of second intermediate lye channels (5b) conducting lye from the second lye inlet channel (4b) to each anode (3b) in the stack, wherein the hydrogen conducting channels include a common hydrogen outlet channel (7a) and a multitude of intermediate hydrogen channels (8a) conducting hydrogen from each cathode (3a) to the common hydrogen outlet channel (7a), and the oxygen conducting channels include a common oxygen outlet channel (7b) and a multitude of intermediate oxygen channels (8b) conducting oxygen from each anode (3b) to the common oxygen outlet channel (7b).

### FIELD OF THE INVENTION

The present invention relates to an electrolyzer for producing hydrogen and oxygen from water under high pressure, the water being present as an electrolyte of potassium or sodium hydroxide. The invention also relates to a corresponding method for producing hydrogen and oxygen from water under high pressure. More specifically, the present invention relates to a design minimizing the parasitic current affiliated with imbedded lye and/or hydrogen/oxygen flow channels inside the electrolyzer body.

### BACKGROUND

Electrolyzers are used in the industry for producing hydrogen and oxygen. There exist many types of electrolyzers functioning in different ways depending on the electrolyte material involved. For producing hydrogen and oxygen, the electrolyzers in use are mainly of the PEM type or the alkaline type. PEM electrolyzers use pure water as the electrolyte, electrodes made from noble metals (e.g. Pt/Pd on the cathode side and Ir/Ru on the anode side), and a proton-conducting Polymer Electrolyte Membrane (PEM) which is often a perfluorinated sulfonic acid polymer separating the electrodes and oxygen and hydrogen. An over-voltage must be applied to the electrodes to enable the electrolysis to take place and the pressure must be at a relatively low level, due to the fragile PEM membrane. Alkaline electrolyzers, on the other hand, use an electrolyte of KOH or NaOH dissolved in water. This allows the use of cheap electrodes often based on nickel. The membrane is porous allowing electrolytes and ions to pass from one side to the other and at the same time prohibiting a cross-over flow of oxygen and hydrogen between the anode side and the cathode side. The optimum voltage for driving the process is typically between 2.0 and 2.5 volts.

A problem with all electrolyzers is that the gases are produced as bubbles that will cling to the electrodes and at least partially fill the chamber of the electrolysis cell. This will restrict the available contact area between electrolyte and electrodes, and thus, reduce the efficiency of the cells. Trying to solve this problem, alkaline electrolyzers have been operated at high pressure, as the design of these electrolyzers will stand the pressure. The high pressure will compact the bubbles and increase the contact area. A benefit of this being the possibility to store the produced oxygen and hydrogen directly at elevated pressure without using a subsequent compressor step. A drawback of this method is that the alkaline electrolyte becomes very aggressive (corrosive) at high pressure and the operating temperature is typically above 80° C.

Another drawback of alkaline electrolyzers is that some of the current supplied to the cell stack will not go the proper way from one electrode to the other, but may pass outside the stacked cells in the conducting electrolyte supplied through lye inflow channels and lye/gas outlet/outflow channels. These shunt currents are directly linked to a loss in the overall efficiency, and are known in the field as parasitic currents due to their undesirable character within electrolyzers. Contributing to the loss is both the lye inflow channels and the lye/gas outflow channels where the electrolyte will be carried away together with the gas stream (about 50% by volume). Both inflow and outflow channels on the hydrogen side and oxygen side, respectively, will conduct shunt/parasitic current. The electrolyte is separated from the gas in outside separators, and returned to the electrolyte through inflow channels.

Furthermore, the shunt currents will generate some gas in the respective gas channel, both hydrogen and oxygen gas, which means that some oxygen is generated in the hydrogen outlet channel and some hydrogen is generated in the oxygen outlet channel. Thus, the produced gases are not entirely pure and may have to be further cleaned before use. Thus, shunt currents will not only lower the efficiency but also lower the quality of the generated hydrogen and oxygen gas.

Hence, an improved alkaline electrolyzer eliminating the above-mentioned drawbacks would be advantageous, and in particular, a more efficient and/or reliable alkaline electrolyzer that can produce hydrogen/oxygen with a higher purity would be an additional advantageous.

### SUMMARY OF THE INVENTION

It is an object of the present invention to provide an alkaline high-pressure electrolyzer with higher efficiency than prior art designs. It is a further an object of the present invention to provide an alkaline high-pressure electrolyzer with low or reduced shunt currents relative to prior art designs.

Thus, one aspect of the invention relates to an alkali highpressure electrolyzer for splitting water into hydrogen and oxygen, said electrolyzer comprising a stack of electrolysis cells, the cells comprising:
cathodes,
anodes,
membranes separating the cathodes from the anodes,
bi-polar plates supporting the cathodes and the anodes,
insulating gaskets separating the cells,
a source of electric power supplying the stack,
channels supplying lye to the cathodes and anodes,
channels conducting hydrogen from the cathodes and oxygen from the anodes, characterized in that
the lye supplying channels include first and second lye inlet channels,
a multitude of first intermediate lye channels conducting lye from the first lye inlet channel to each cathode in the stack,
a multitude of second intermediate lye channels conducting lye from the second lye inlet channel to each anode in the stack,
the hydrogen conducting channels include a common hydrogen outlet channel and a multitude of intermediate hydrogen channels conducting hydrogen from each cathode to the common hydrogen outlet channel, and
the oxygen conducting channels include a common oxygen outlet channel and a multitude of intermediate oxygen channels conducting oxygen from each anode to the common oxygen outlet channel.

The invention is particularly, but not exclusively, advantageous for obtaining significantly reduced shunt currents when performing H₂ production by electrolysis due to the first and second intermediate lye channels, and common hydrogen and oxygen outlet channels having extended lengths with correspondingly increased current path length and thereby increased resistance as seen by the shunt currents. Initial tests performed by the inventor indicate that the hydrogen production can be increased up to 23%, which is a remarkable result, cf. detailed description below, especially FIG. 8 and the corresponding description.

Furthermore, the present invention will facilitate the production of hydrogen/oxygen with a higher purity due to the elimination of hydrogen/oxygen production in the inflow/outflow channels in the oxygen and hydrogen circuits.

### Definitions

Prior to discussing the present invention in further details, the following terms and conventions will first be defined:
Alkaline elektrolyser: As the skilled person will understand a stacked system of anodes, membranes, and cathodes sandwiched between bipolar plates held together between two endplates.
High pressure: With high pressure is meant an alkaline electrolyzer operating above atmospheric pressure i.e. around 1.00-1.01 bar. It could in some cases be 15, 20, 25, 30 bar or even higher.
Lye: With the term lye is meant KOH or NaOH dissolved in water as the skilled person will understand. Typical lye concentrations could be around 30 wt %, but other concentrations such as 20 wt %, 25 wt %, 35 wt % or 40 wt % could be applied for some embodiments.
Minimum length: With the term minimum length is meant the possible length of the hoses or tubes if they were connected directly i.e. with the minimum spatially distance for fluid connection, the hoses or tubes used in the present invention being larger than such a minimum distance. The length applied by the hoses or tubes in the present invention could be more than e.g. 5 cm, 10 cm, 20 cm, 30 cm, 40 cm or even larger than 40 cm, larger than 50 cm, or larger than 60 cm, depending on the desired reduction in parasitic current when implementing the present invention. It is to be understood that each hose or tube may have a corresponding minimum length, i.e. they could be different, but for many practical applications with a stack of electrolysis cells being substantially identically their connecting hoses or tubes could likewise be substantially similar, and hence have substantially the same minimum length from one cell to the next cell.

In some embodiments, the first and second lye inlet channels may be located external to the electrolyzer stack, which may facilitate further increasing the path length of flow, and the hence reduce the shunt current.

Alternatively or additionally, the intermediate lye channels may beneficially be electrically isolated tubes or hoses connecting the first and second lye inlet channels to the respective cathodes and anodes in the stack.

In other embodiments, the spatial paths of the intermediate lye channels connecting the first and second lye inlet channels to the respective cathodes and anodes in the stack forming electrical insulated flow channels may have lengths being larger than a corresponding minimum length in order to reduce the shunt currents. As defined above, said minimum length may be taken as the shortest possible length and hence the intermediate lye channels will have an additional increased flow length according to the present invention. More specifically, the spatial paths of the intermediate lye channels connecting the first and the second lye inlet channels to the respective cathodes and anodes in the stack forming electrical insulated flow channels having lengths being at least 5 cm long, preferably at least 10 cm long, most preferably at least 20 cm long. In a certain layout, the non-conducting flow channels could be up to 20 cm long. Alternatively, they could be up to 30 cm long. More alternatively, they could be up to 40 cm long or even longer.

In still other embodiments, the electrolyzer may have at least part of the spatial paths of the intermediate lye channels being non-linear, preferably being at least partially curved, twisted, and/or spiralling, so as to increase the flow path, especially longer than the defined minimum length.

In advantageous embodiments, the hydrogen and oxygen outlet channels may be located external to the electrolyzer stack, which may facilitate further increasing the flow path length, and hence, reduce the shunt currents.

Alternatively or additionally, the intermediate hydrogen and oxygen channels may be tubes or hoses connecting the cathodes to the hydrogen outlet channel and the anodes to the oxygen outlet channel.

In some embodiments, the spatial paths of the intermediate hydrogen and oxygen channels connecting the cathodes to the hydrogen outlet channel and the anodes to the oxygen outlet channel forming electrical insulated flow channels may have lengths being larger than a corresponding minimum length in order to reduce the shunt current. More specifically, the spatial paths of the intermediate hydrogen and oxygen channels connecting the cathodes to the hydrogen outlet channel and the anodes to the oxygen outlet channel forming electrical insulated flow channels having lengths, which may be at least 5 cm long, preferably at least 15 cm long, most preferably at least 35 cm long. In certain embodiments, the length could be up to 40 cm long, preferably at least 50 cm long, most preferably at least 70 cm long.

In some embodiments, the spatial paths of the intermediate hydrogen and oxygen channels may be non-linear, preferably being at least partially curved, twisted, and/or spiralling etc. for increasing the flow path length, and hence reduce the shunt current.

In some embodiments, the intermediate hydrogen and oxygen channels may be connected to the cathode and the anode, respectively, through the rim of the bi-polar plate, the intermediate channels being connected by connection points to the rim in points offset from each other along the periphery of the rim. More specifically, these connection points may be alternately offset along the rim compared to neighbouring bi-polar plates for an improved design.

In still other advantageous embodiments, the intermediate hydrogen and oxygen channels may be passing an elevated position before entering the respective hydrogen and oxygen outlet channels, i.e. the elevated position may form a local maximum in the flow channel. This may further increase the flow path length, and hence reduce the shunt current.

In some beneficial embodiments, the tubes or hoses are made from electrically insulating materials, preferably polymer or ceramic material.

In some particularly beneficial embodiments, the electrolyzer may be arranged with circumferential positions, as seen from an end point of the stack of electrolysis cells, of:
the intermediate lye channels, and
the intermediate hydrogen and oxygen channels,
   being evenly distributed, and this may further increase the shunt resistance by separating the various channels even further, preferably they may be separated by approximately 90 degrees. Thus, the 90 degree configuration may correspond to a so-called cross-flow configuration when comparing the flow direction in the anode with the flow direction in the cathode.

In a particular embodiment, the electrolyzer may have a sub-set of the electrolysis cells from the stack, which may be operated without the remaining electrolysis cells outside the sub-set being operated. This can, for example, be obtained in a generalized N cell electrolyzer system grouped into N/x sub-groups, where the flow from the x groups of x cells is merged into individual manifolds before being combined in the shared manifold. In this segmented approach, there is an increased shunt resistance only for a part of the stack of electrolysis cells, which may—in some embodiments—be a particular advantage of the invention.

In a second aspect, the invention relates to an alkali high-pressure electrolyzer for splitting water into hydrogen and oxygen, said electrolyzer comprising a stack of electrolysis cells, the cells comprising:
cathodes,
anodes,
membranes separating the cathodes from the anodes,
bi-polar plates supporting the cathodes and anodes,
insulating gaskets separating the cells,
a source of electric power supplying the stack,
one or more channels supplying lye to the cathodes and the anodes, and/or
one or more channels conducting hydrogen from the cathodes and oxygen from the anodes,
characterized in that
the, one or more, lye supplying channel(s) include first and/or second lye inlet channels,
a multitude of first intermediate lye channels conducting lye from the first lye inlet channel to each cathode in the stack,
and/or
a multitude of second intermediate lye channels conducting lye from the second lye inlet channel to each anode in the stack,
the, one or more, hydrogen conducting channels include a common hydrogen outlet channel and a multitude of intermediate hydrogen channels conducting hydrogen from each cathode to the common hydrogen outlet channel,
and/or
the, one or more, oxygen conducting channels include a common oxygen outlet channel and a multitude of intermediate oxygen channels conducting oxygen from each anode to the common oxygen outlet channel.

Advantageously, in the second aspect of the present invention, the various combinations of first and second intermediate lye channels conducting lye with various combinations of intermediate hydrogen and oxygen channels can also be implemented in the context of the present invention as the skilled person will readily understand from the general teaching and principle of the first aspect of the invention. This is explained in more detail in connection with FIG. 6 and the detailed description below.

Advantageously, in the third aspect of the present invention, the invention relates to a method for performing alkali high-pressure electrolysis by splitting water into hydrogen and oxygen in an electrolyzer comprising a stack of electrolysis cells, the cells comprising:
cathodes,
anodes,
membranes separating the cathodes from the anodes,
bi-polar plates supporting the cathodes and the anodes,
insulating gaskets separating the cells,
a source of electric power supplying the stack,
one or more channels supplying lye to the cathodes and anodes, and/or
one or more channels conducting hydrogen from the cathodes and oxygen from the anodes,
characterized in that the method comprises
supplying lye via the, one or more, channel(s) including first and/or second lye inlet channels,
conducting lye via a multitude of first intermediate lye channels from the first lye inlet channel to each cathode in the stack,
and/or
conducting lye via a multitude of second intermediate lye channels from the second lye inlet channel to each anode in the stack,
conducting hydrogen via the, one or more, hydrogen conducting channels including a common hydrogen outlet channel in a multitude of intermediate hydrogen channels from each cathode to the common hydrogen outlet channel,
and/or
conducting oxygen via the, one or more, oxygen conducting channels including a common oxygen outlet channel and a multitude of intermediate oxygen channels from each anode to the common oxygen outlet channel.

Advantageously, in the third aspect of the present invention, the various steps of conducting lye via the first and second intermediate lye channels with the various steps of conducting hydrogen and oxygen via the intermediate channels can also be implemented for reduced shunt currents in the context of the present invention as the skilled person will readily understand from the general teaching and principle of the first and/or second aspect of the invention.

In the fourth aspect, the present invention relates to an advantageous application of a Polymer Electrolyte Membrane (PEM) electrolyzer for splitting water into hydrogen and oxygen, said electrolyzer comprising a stack of electrolysis cells, the cells comprising:
cathodes,
anodes,
membranes separating the cathodes from the anodes,
bi-polar plates supporting the cathodes and the anodes,
insulating gaskets separating the cells,
a source of electric power supplying the stack,
one or more channels supplying deionized water to the cathodes and anodes,
one or more channels conducting hydrogen from the cathodes and oxygen from the anodes,
characterized in that
the, one or more, deionized water supplying channel(s) include first and/or second deionized water channels,
a multitude of first intermediate deionized water channels conducting deionized water from the first deionized water inlet channel to each cathode in the stack,
and/or
a multitude of second intermediate deionized water channels conducting deionized water from the second deionized water inlet channel to each anode in the stack,
the, one or more, hydrogen conducting channels include a common hydrogen outlet channel and a multitude of intermediate hydrogen channels conducting hydrogen from each cathode to the common hydrogen outlet channel,
and/or
the, one or more, oxygen conducting channels include a common oxygen outlet channel and a multitude of intermediate oxygen channels conducting oxygen from each anode to the common oxygen outlet channel.

Advantageously, in the fourth aspect of the present invention, the general teaching and principle of the invention according to the first, second, and/or third aspect can readily be applied generally for an electrolyzer system of the PEM-type like the skilled person in electrolysis will immediately understand, because also for PEM electrolysis shunt currents are not desirable for efficient and/or reliable hydrogen production. Thus, relative to the alkaline electrolysis, the lye is replaced with substantially deionized water supplied to cathodes and/or anodes of cells in the PEM electrolysis system. It may be an advantage that there is an improved cleanliness of the generated oxygen and hydrogen due to reduced/elimination of hydrogen formed in the oxygen-related flow channels and oxygen formed in the hydrogen-related flow channels.

The first, second, third, and fourth aspects of the present invention may each be combined with any of the other aspects. These and other aspects of the invention will be apparent from and elucidated with reference to the embodiments described hereinafter.

### BRIEF DESCRIPTION OF THE DRAWINGS

The invention will now be described in detail with reference to the appended drawings, in which

FIG. 1 is a schematic sketch showing the main components of a prior art alkaline electrolyzer, in side view revealing an inflow lye channel and an outflow gas/lye channel both embedded inside the electrolyzer body,

FIG. 2 is an end view of the electrolyzer shown in FIG. 1,

FIG. 3 is a section through the prior art electrolyzer,

FIG. 4 is a perspective view of a bi-polar plate used in the prior art electrolyzer,

FIG. 5 is a schematic sketch showing the main components of a first embodiment of an alkaline electrolyzer according to the present invention, in side view,

FIG. 6 is an end view of the electrolyzer shown in FIG. 5,

FIG. 7 is a perspective view of a bi-polar plate used in the inventive electrolyzer,

FIG. 8 is a comparative graph showing the hydrogen (H₂) as a function of DC current with and without the present invention revealing that significantly more hydrogen is formed utilizing the present invention,

FIG. 9 is a photograph of a test cell according to the present invention, and

FIG. 10 is flow-chart of a method according to the present invention.

### DETAILED DESCRIPTION

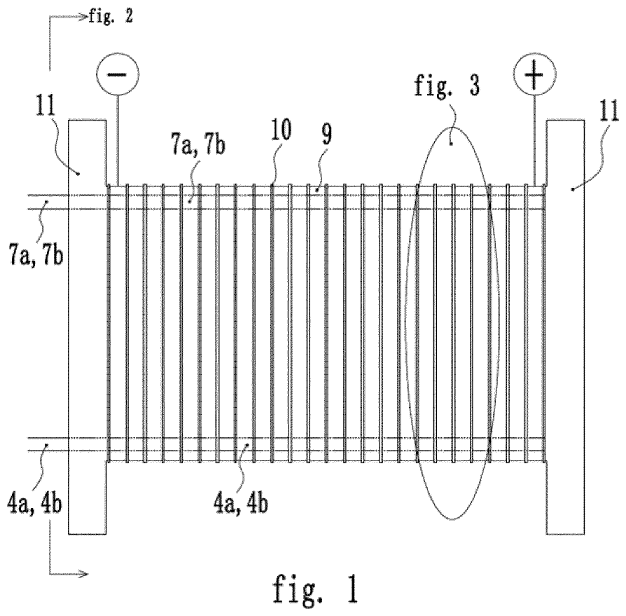

FIG. 1 shows the layout of a conventional alkaline electrolyzer. The electrolyzer includes a number of circular electrolysis stacks 1 with cells 9 arranged in an elongate stack (bipolar plate, anode, membrane, cathode and bipolar plate). The stack is held together by end plates 11 and bolts. The individual cells are electrically insulated from each other by gaskets 10. The electric power is supplied to the outermost cells in the stack, indicated by the + and − signs in the figure. The electric potential will be distributed along the stack, ideally supplying each stack with the same current density and a potential between 2-2.5 volt. Lye is supplied as electrolyte to the cells in common internal channels running through the stack, wherein one channel 4a is supplying lye to the cathodes and one channel 4b is supplying lye to the anodes. Likewise, there are common internal channels conducting gases and excess lye/water from the cells, i.e. one channel 7a conducting hydrogen from all the cathodes in the stack, and one channel 7b conducting oxygen from the anodes.

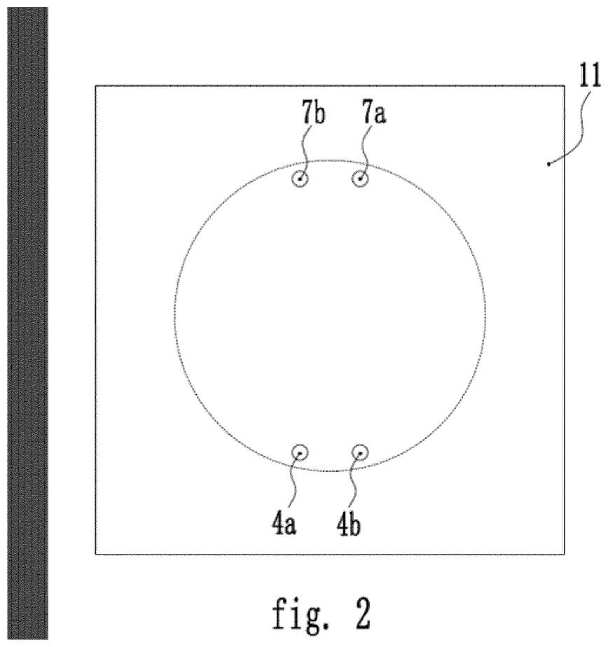

FIG. 2 shows the electrolyzer in cross section. The lye inlet channels 4a, 4b are located at the bottom of the stack, while the gas outlet channels 7a, 7b are located towards the top of the stack.

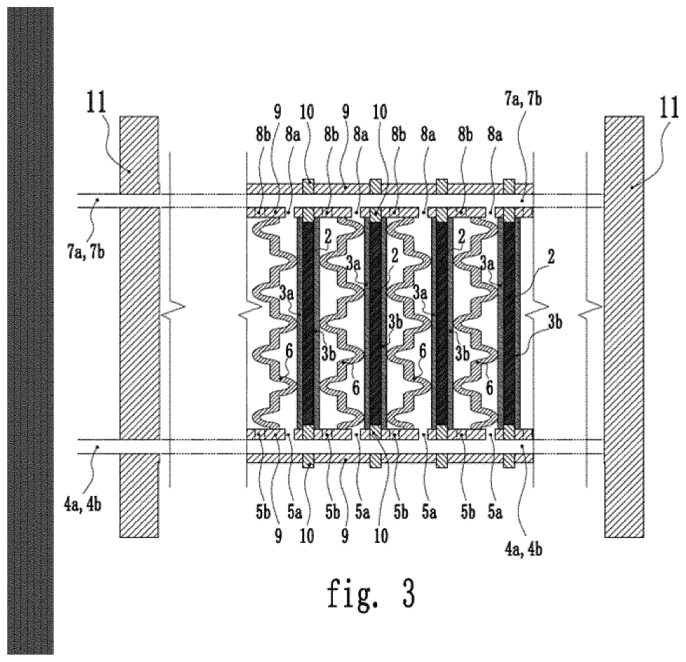

FIG. 3 is an internal view of the electrolyzer stack showing how the electrolysis cells are designed. Each cell 9 includes a circular bi-polar plate with a rim portion and a centre portion 6 welded to the rim. The centre portion has a number of protrusions or bumps making room for the electrode and flow of the gas/lye in each electrolysis cell. Between each bi-polar plate there is an annular insulating gasket 10 supporting a membrane 2. The membrane is made from an insulating material that is chemically stable in the electrolyte. On each side of the membrane there is an electrode 3a, 3b made from e.g. nickel foam. Thus, the electrolyte will penetrate the electrodes as well as the membrane. When electric power is applied to the end plates, the potential will be distributed among the cells in the stack such that each bi-polar plate will support both a cathode 3a and an anode 3b even though both electrodes are at the same potential. The electrodes are supported by the protrusions in the centre portions, each protrusion pushing against a protrusion in an adjacent cell.

The lye channels 4a, 4b are supplying lye to each cell through small openings 5a, 5b, i.e. the common inlet channel 4a supplying lye to the cathode sides 3a of the cells through the openings 5a, while the common channel 4b is supplying lye to the anode sides 3b of the cells through the openings 5b.

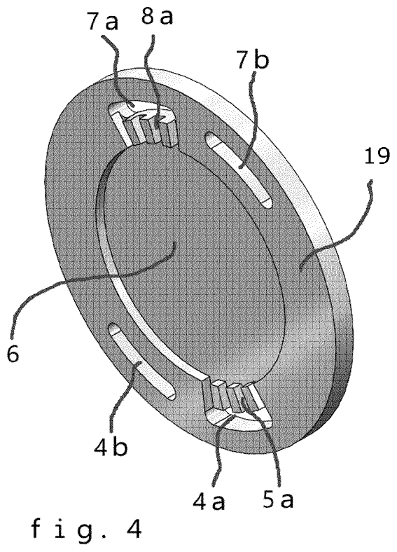

A schematic view of a conventional bi-polar plate is shown in FIG. 4. The plate includes a rim 19 with broad channels 4a, 4b near the bottom for the lye electrolyte and broad channels 7a, 7b near the top of the plate enabling the flow of lye and the generated hydrogen and oxygen away from the cathode and anode, respectively. The plate is symmetric, the figure showing the cathode side of the plate. The lye is supplied to the cathode from the broad channel 4a through the short openings 5a. Similarly, the hydrogen gas is conducted from the cell to the common outlet channel 7a through the openings 8a. Note that the figure does not show the protrusions in the centre portion 6.

A shortcoming of this arrangement is that some of the electric current supplied to the end plates 11 (in FIG. 1) will find a short path along the common lye channels 4a, 4b and not enter the electrodes doing its intended purpose. Another shortcoming is that some lye will follow among the gas conducted out of the cell creating another conducting path in the common channels in the exit flow channels running outside the cells but still embedded inside the electrolyzer body.

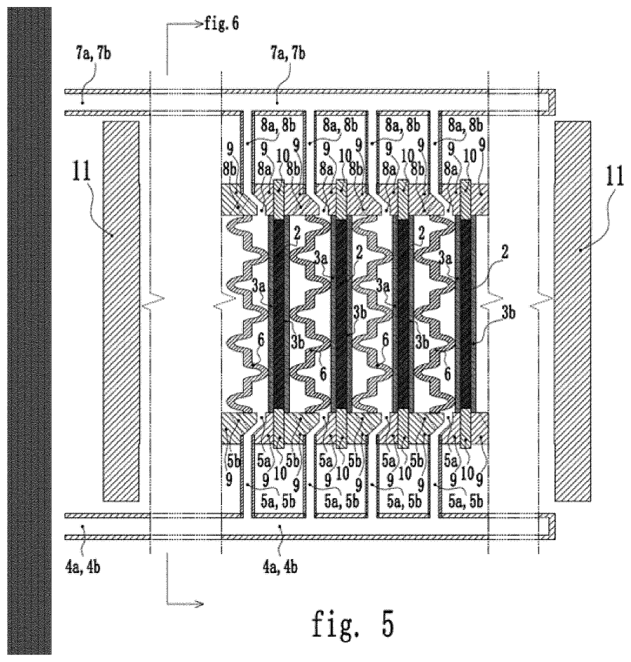

Briefly stated, FIGS. 5, 6, and 7 illustrate an alternative arrangement of the inlet/outlet channels according to a first preferred embodiment of the present invention. The common channels 4a, 4b, 7a, 7b are located outside the main electrolyzer body and connected to the bi-polar plates through a number of intermediate channels 5a, 5b and 8a, 8b. This arrangement ensures that the shunt or short/parasitic current passing outside the cells has to go a much longer way. This prolonged path increases the resistance faced by the shunt current which then will be significantly diminished. Clearly, this will increase the efficiency of the electrolyzer cell stack 1.

FIG. 5 is a schematic sketch showing the main components of a first embodiment of an alkaline electrolyzer according to the present invention, in side view.

Thus, an alkali high-pressure electrolyzer for splitting water into hydrogen and oxygen is shown, preferably operating at a pressure from around atmospheric pressure up to 10, 20, 30, 40 bar or even higher. The electrolyzer comprises a stack of electrolysis cells with cathodes 3a and anodes 3b, and corresponding membranes 2 separating the cathodes from the anodes. Additionally, bi-polar plates 6 are supporting the cathodes and anodes. Insulating gaskets 10 are separating the cells as shown in FIG. 5, and the electrolyzer is arranged with a source of electric power supplying the stack. Channels 4 supplying lye to the cathodes and anodes are provided in the lower part of FIG. 5, together with channels 7 conducting hydrogen from the cathodes and oxygen from the anodes in the upper part of FIG. 5.

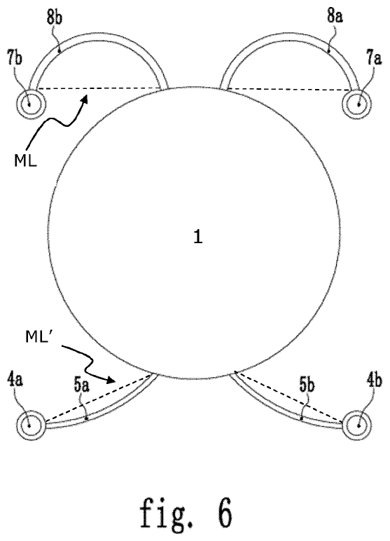

The invention is particular in that the lye supplying channels include first and second lye inlet channels 4a, 4b conveying lye into the stack of electrolysis cells with a multitude of first intermediate lye channels 5a conducting lye from the first lye inlet channel 4a to each cathode 3a in the stack, and a multitude of second intermediate lye channels 5b conducting lye from the second lye inlet channel 4b to each anode 3b in the stack, cf. also end view in the lower part of FIG. 6. Preferably, these intermediate lye channels forming electrical insulated flow channels have lengths being larger than a minimum length ML in order to reduce the shunt current, the minimum length being the theoretical or hypothetical shortest distance for conveying the lye into the cell. Thus, the current path is intentionally increased, and the corresponding parasitic current will be reduced.

Additionally, the hydrogen conducting channels include a common hydrogen outlet channel 7a and a multitude of intermediate hydrogen channels 8a conducting hydrogen from each cathode 3a to the common hydrogen outlet channel 7a, and the oxygen conducting channels include a common oxygen outlet channel 7b and a multitude of intermediate oxygen channels 8b conducting oxygen from each anode 3b to the common oxygen outlet channel 7b. cf. also end view in the upper part in FIG. 6. Preferably, these intermediate hydrogen and oxygen channels are forming electrical insulated flow channels having lengths being larger than a minimum length ML in order to reduce the shunt current, the minimum length being the theoretical or hypothetical shortest distance for conveying the hydrogen and/or oxygen out from the cell.

FIG. 6 is an end view of the electrolyzer shown in FIG. 5. In the lower part of FIG. 6, it is apparent that the first and second lye inlet channels 4a, 4b are located external to the electrolyzer stack 1, and the intermediate lye channels 5a, 5b are, for example, electrical isolated tubes or hoses connecting the first and second lye inlet channels 4a, 4b to the respective cathodes and anodes 3a, 3b in the stack 1. As shown in FIG. 6, the spatial paths of the intermediate lye channels 5a, 5b connecting the first and second lye inlet channels 4a, 4b to the respective cathodes and anodes 3a, 3b in the stack forming electrical insulated flow channels having lengths being larger than the minimum length ML′ schematically shown in two dimensions (in reality the minimum length is of course three-dimensional), the spatial length being at least 5 cm long, preferably at least 10 cm long, most preferably at least 20 cm long or even longer.

In the upper part of FIG. 6, the spatial paths of the intermediate hydrogen and oxygen channels 8a, 8b connecting the cathodes 3a in the stack 1 to the hydrogen outlet channel 7a and the anodes 3b to the oxygen outlet channel 7b are shown and the channels 8 form electrical insulated flow channels that have a length being larger than a minimum length ML, schematically shown in both sides, in order to reduce the shunt current by the increased current path length. These flow channel lengths being at least 5 cm long, preferably at least 10 cm long, most preferably at least 20 cm long, or even longer, depending on the electrolyzer and the operating conditions of the electrolyzer, and the desired need for reducing parasitic currents, and correspondingly increased hydrogen production and purity of the hydrogen production.

Referring to FIG. 6 and the above description, it is also apparent that the present invention may be implemented in a manner, where, for example, only the lower intermediate lye channels 5a, 5b are implemented but without the upper intermediate hydrogen and oxygen channels 8a, 8b, and still there may be some advantage from the present invention i.e. a reduced shunt current. Oppositely, it is also evident that the reverse situation could be implemented i.e. where, for example, only the upper intermediate hydrogen and oxygen channels 8a, 8b are applied, but not the lower intermediate lye channels 5a, 5b, and still there may be some advantage from the present invention.

Moreover, it is further apparent that only one side of the upper intermediate hydrogen and oxygen channels 8a, 8b, e.g., the left intermediate channel 8b could be applied within the context of the present invention. Likewise, is further apparent that only one side of the lower intermediate lye channel, e.g., the right intermediate lye channel 5b could be applied within the context of the present invention, and still some advantage i.e. a reduced shunt current could be obtained.

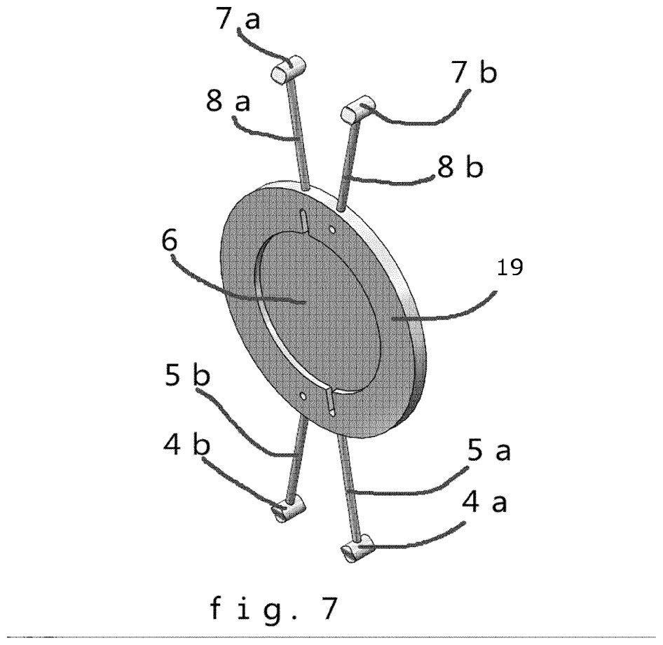

FIG. 7 is a perspective view of a bi-polar plate used in the electrolyzer with a centre portion 6 and a rim part 19. The view is similar to FIG. 4, but in FIG. 7 the intermediate lye channels 5a and 5b now have an extended length providing the additional shunt resistance. Similarly, the intermediate hydrogen channel 8a and intermediate oxygen channel 8b also have an extended length providing the additional shunt resistance. In FIG. 7, the intermediate lye channels, the intermediate hydrogen channel, and the intermediate oxygen channel are shown in an exploded view without any curvature of the channels, and hence when mounted in a stack of electrolysis cells, the actual shape of the channels could, for example, have a curvature like shown in the cross-sectional view of FIG. 6. Thus, in FIG. 7, the channels 8a, 8b, 5a, and 5b have a straight shape unlike the curved shape in FIG. 6.

Two test units were constructed and tested according to the present invention: Unit (i) based on conventional technology with two long internal lye/H₂O feed channels for the H₂/cathode and the O₂/anode systems, respectively. Hereto, two internal exit channels for the lye/H₂O/O₂ and lye/H₂O/H₂ exit lines.

Unit (ii) based on the present invention with individual external input and external output channels for lye/H₂O feeds and external lye/H₂O/O₂ and lye/H₂O/H₂ exit lines from the anode and cathode parts of the cells, respectively.

Tabel 1 below provides the measured H₂ flow as a function of the supplied current to the conventional electrolyzer configuration as well as for the present invention.

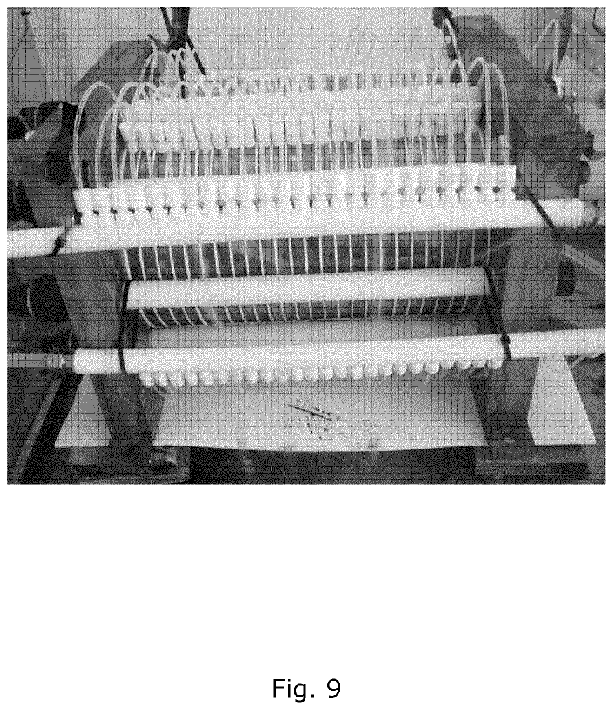

TABLE 1
(Left) Hydrogen formation as a function of the applied DC current
for a standard test unit (conventional design) with internal
flow channels. (Right) Hydrogen formation as a function of
the applied DC current for the present invention (new design), cf.
FIG. 9 with a photograph of a test cell according to the present invention
with the measured hydrogen formation (m³/h) as a function of
the applied current (A) for the present invention and for the
conventional electrolyzer design.

| | |
|---|---|
| Table 1(a) | Table 1(b) |
| (Conventional | (New |
| design) | design) |

| DC | Hydrogen | DC | Hydrogen |
|---|---|---|---|
| current | flow | current | flow |
| (A) | (m³/h) | (A) | (m³/h) |
| 16 | 0.117 | 8 | 0.085 |
| 16 | 0.115 | 8 | 0.085 |
| 16 | 0.113 | 8 | 0.085 |
| 24 | 0.200 | 8 | 0.086 |
| 24 | 0.199 | 8 | 0.087 |
| 24 | 0.199 | 16 | 0.172 |
| 32 | 0.284 | 16 | 0.171 |
| 32 | 0.283 | 16 | 0.171 |
| 32 | 0.280 | 24 | 0.260 |
| 32 | 0.283 | 24 | 0.260 |
| 32 | 0.280 | 32 | 0.347 |
| 32 | 0.279 | 32 | 0.347 |

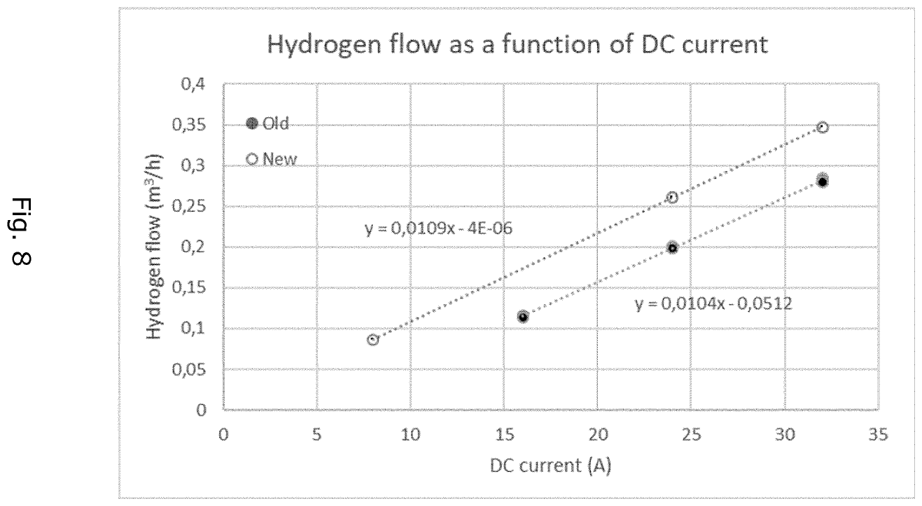

FIG. 8 is a comparative graph based on Table 1 showing the amount of generated hydrogen (H₂) as a function of the applied DC current with—and without—the present invention. As an example, the new configuration is generating e.g. 0,347/0,281=1,23 at 32A, i.e. a remarkable 23% increase in the amount of formed hydrogen due to the elimination of the shunt current running in the flow channels according to the present invention.

The amount of hydrogen produced by an electrolyzer unit can in principle be expressed as:

$$Production of hydrogen = constant \times [ number of cells ] \times I \times μ$$

In other words, doubling the number of cells or doubling the current, I, through the cell stack will cause a doubling of the amount of produced hydrogen. The efficiency constant μ is related to a lowering in the overall electrolyzer efficiency cause by the shunt current running in the flow channels. Depending on the electrolyzer size and/or current load, the efficiency μ is typically between 0.9 and 1 where a value close to 1 is obtainable with the present invention. For the current measurement in the case of the smaller electrolyzer illustrated in the present case it corresponds to an increase from around μ=0.8 to around μ=1.

The shunt resistance (SR) can be modelled by a simple Ohmic model:

$$SR = Constant \times Electrochemical Resistivity \times Path Length / cross - sectional tubing area ,$$

Hence, increasing the length of the non-conducting tubings will increase the shunt resistance increasing the overall electrolyzer efficiency. In principle, the longer tubings the better although in practice this is not feasible because of the required flow of ingoing lye and/or outgoing flow of hydrogen and oxygen. Tubing with a length between 10-30 cm is recommended within the teaching and principle of the present invention, though of course longer tube lengths, e.g. 30-50 cm or 50-80 cm, can also be contemplated in the context of the present invention.

Hence, decreasing the cross-sectional area of the non-conducting tubings would additionally or alternatively, increase the shunt resistance. Typically, tube diameters may be values like 0.635 cm/0.25 inch, 0.32 cm/0.125 inch, 0.165 cm/0.063 inch or other standard diameters, etc.

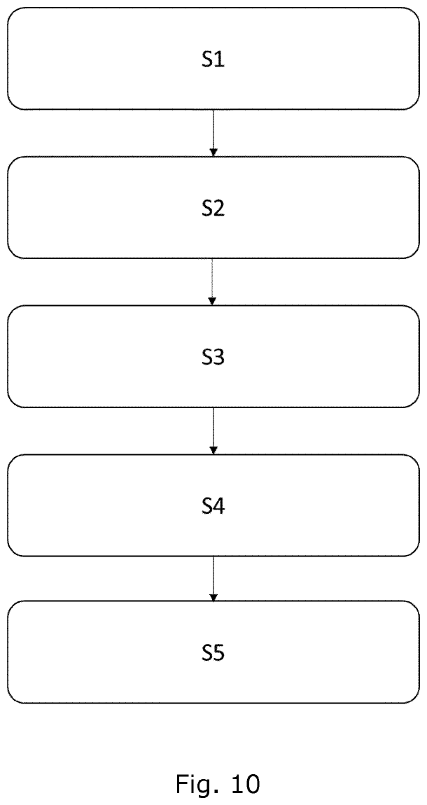

FIG. 10 is a flow-chart of a method according to the present invention. Thus, in this aspect, the invention relates to a method for performing alkali high-pressure electrolysis by splitting water into hydrogen and oxygen in an electrolyzer comprising a stack of electrolysis cells 1, cf. FIG. 5, the cells comprising:
cathodes 3a,
anodes 3b,
membranes 2 separating the cathodes from the anodes,
bi-polar plates 6, 19 supporting the cathodes and anodes,
insulating gaskets 10 separating the cells,
a source of electric power supplying the stack,
one or more channels supplying lye to the cathodes and anodes, and/or
one or more channels conducting hydrogen from the cathodes and oxygen from the anodes,
characterized in that the method comprises, cf. FIG. 6,
S1 supplying lye via the, one or more, channel(s) including first and/or second lye inlet channels 4a, 4b,
S2 conducting lye via a multitude of first intermediate lye channels 5a from the first lye inlet channel 4a to each cathode 3a in the stack, and/or
S3 conducting lye via a multitude of second intermediate lye channels 5b from the second lye inlet channel 4b to each anode 3b in the stack,
   S4 conducting hydrogen via the, one or more, hydrogen conducting channels including a common hydrogen outlet channel 7a in a multitude of intermediate hydrogen channels 8a from each cathode 3a to the common hydrogen outlet channel 7a,
and/or
   S5 conducting oxygen via the, one or more, oxygen conducting channels including a common oxygen outlet channel 7b and a multitude of intermediate oxygen channels 8b from each anode 3b to the common oxygen outlet channel 7b.

As the skilled person will understand, these steps may be performed substantially simultaneously or in a sequence of steps depending on the specific embodiment of the present invention.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements, steps, or designs. Also, the mentioning of references such as “a” or “an”, etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. An alkali high-pressure electrolyzer for splitting water into hydrogen and oxygen, said electrolyzer comprising a stack of electrolysis cells (9), the cells comprises:
cathodes (3a),
anodes (3b),
membranes (2) separating the cathodes from the anodes,
bi-polar plates (6, 19) supporting the cathodes and anodes,
insulating gaskets (10) separating the cells,
a source of electric power supplying the stack,
channels supplying lye to the cathodes and anodes,
channels conducting hydrogen from the cathodes and oxygen from the anodes,
characterized in that
the lye supplying channels include first and second lye inlet channels (4a, 4b),
a multitude of first intermediate lye channels (5a) conducting lye from the first lye inlet channel (4a) to each cathode (3a) in the stack,
a multitude of second intermediate lye channels (5b) conducting lye from the second lye inlet channel (4b) to each anode (3b) in the stack,
the hydrogen conducting channels include a common hydrogen outlet channel (7a) and a multitude of intermediate hydrogen channels (8a) conducting hydrogen from each cathode (3a) to the common hydrogen outlet channel (7a), and
the oxygen conducting channels include a common oxygen outlet channel (7b) and a multitude of intermediate oxygen channels (8b) conducting oxygen from each anode (3b) to the common oxygen outlet channel (7b).

2. An electrolyzer according to claim 1, wherein the first and second lye inlet channels (4a, 4b) are located externally to the electrolyzer stack, and the intermediate lye channels (5a, 5b) are made from electrical isolated tubes or hoses connecting the first and second lye inlet channels (4a, 4b) to the respective cathodes and anodes (3a, 3b) in the stack.

3. An electrolyzer according to claim 1, wherein the spatial paths of the intermediate lye channels (5a, 5b) connecting the first and second lye inlet channels (4a, 4b) to the respective cathodes and anodes (3a, 3b) in the stack are made from electrical insulated flow channels having lengths being larger than a minimum length (ML′) in order to reduce the shunt current.

4. An electrolyzer according to claim 3, wherein the spatial paths of the intermediate lye channels (5a, 5b) connecting the first and second lye inlet channels (4a, 4b) to the respective cathodes and anodes (3a, 3b) in the stack forming electrical insulated flow channels having lengths being at least 5 cm long, preferably at least 10 cm long, most preferably at least 20 cm long.

5. An electrolyzer according to claim 3, wherein at least part of the spatial paths of the intermediate lye channels (5a, 5b) are non-linear, preferably being at least partially curved, twisted, and/or spiralling.

6. An electrolyzer according to claim 1, wherein the hydrogen and oxygen outlet channels (7a, 7b) are located external to the electrolyzer stack, and the intermediate hydrogen and oxygen channels (8a, 8b) are non-conducting tubes or hoses connecting the cathodes (3a) to the hydrogen outlet channel (7a) and the anodes (3b) to the oxygen outlet channel (7b).

7. An electrolyzer according to claim 1, wherein the spatial paths of the intermediate hydrogen and oxygen channels (8a, 8b) connecting the cathodes (3a) to the hydrogen outlet channel (7a) and the anodes (3b) to the oxygen outlet channel (7b) forming electrical insulated flow channels having lengths being larger than a minimum length (ML) in order to reduce the shunt current.

8. An electrolyzer according to claim 7, wherein the spatial paths of the intermediate hydrogen and oxygen channels (8a, 8b) connecting the cathodes (3a) to the hydrogen outlet channel (7a) and the anodes (3b) to the oxygen outlet channel (7b) forming electrical insulated flow channels having lengths being at least 5 cm long, preferably at least 15 cm long, most preferably at least 35 cm long.

9. An electrolyzer according to claim 6, wherein the spatial paths of the intermediate hydrogen and oxygen channels (8a, 8b) are non-linear, preferably being at least partially curved, twisted, and/or spiralling

10. An electrolyzer according to claim 1, wherein said intermediate hydrogen and oxygen channels (8a, 8b) are connected to cathodes and anodes through the rim (19) of the bi-polar plate, the intermediate channels being connected by connection points to the rim in points offset from each other along the periphery of the rim.

11. An electrolyzer according to claim 10, wherein said connection points are alternately offset along the rim compared to neighbouring bi-polar plates.

12. An electrolyzer according to claim 6, wherein the intermediate hydrogen and oxygen channels are passing an elevated position before entering the respective hydrogen and oxygen outlet channels.

13. An electrolyzer according to claim 2, wherein said tubes or hoses are made from electrically insulating materials, preferably polymer or ceramic material.

14. An electrolyzer according to claim 1, wherein the circumferential positions, as seen from an end point of the stack of electrolysis cells, of:
the intermediate lye channels (5a, 5b), and
the intermediate hydrogen and oxygen channels (8a, 8b),
are evenly distributed, preferably separated by approximately 90 degrees.

15. An electrolyzer according to claim 1, wherein a sub-set of the electrolysis cells from the stack can be operated without the remaining electrolysis cells outside the sub-set being operated.

16. An alkali high-pressure electrolyzer for splitting water into hydrogen and oxygen, said electrolyzer comprising a stack of electrolysis cells (9), the cells comprising:
cathodes (3a),
anodes (3b),
membranes (2) separating the cathodes from the anodes,
bi-polar plates (6, 19) supporting the cathodes and anodes,
insulating gaskets (10) separating the cells,
a source of electric power supplying the stack,
one or more channels supplying lye to the cathodes and anodes, and/or one or more channels conducting hydrogen from the cathodes and oxygen from the anodes,
characterized in that
the, one or more, lye supplying channel(s) include first and/or second lye inlet channels (4a, 4b),
a multitude of first intermediate lye channels (5a) conducting lye from the first lye inlet channel (4a) to each cathode (3a) in the stack,
and/or
a multitude of second intermediate lye channels (5b) conducting lye from the second lye inlet channel (4b) to each anode (3b) in the stack,
the, one or more, hydrogen conducting channels include a common hydrogen outlet channel (7a) and a multitude of intermediate hydrogen channels (8a) conducting hydrogen from each cathode (3a) to the common hydrogen outlet channel (7a),
and/or
the, one or more, oxygen conducting channels include a common oxygen outlet channel (7b) and a multitude of intermediate oxygen channels (8b) conducting oxygen from each anode (3b) to the common oxygen outlet channel (7b).

17. A method for performing alkali high-pressure electrolysis by splitting water into hydrogen and oxygen in an electrolyzer comprising a stack of electrolysis cells (1), the cells comprising:
cathodes (3a),
anodes (3b),
membranes (2) separating the cathodes from the anodes,
bi-polar plates (6, 19) supporting the cathodes and anodes,
insulating gaskets (10) separating the cells,
a source of electric power supplying the stack,
one or more channels supplying lye to the cathodes and anodes, and/or one or more channels conducting hydrogen from the cathodes and oxygen from the anodes,
characterized in that the method comprises
supplying lye via the, one or more, channel(s) including first and/or second lye inlet channels (4a, 4b),
conducting lye via a multitude of first intermediate lye channels (5a) from the first lye inlet channel (4a) to each cathode (3a) in the stack,
and/or
conducting lye via a multitude of second intermediate lye channels (5b) from the second lye inlet channel (4b) to each anode (3b) in the stack,
conducting hydrogen via the, one or more, hydrogen conducting channels including a common hydrogen outlet channel (7a) in a multitude of intermediate hydrogen channels (8a) from each cathode (3a) to the common hydrogen outlet channel (7a),
and/or
conducting oxygen via the, one or more, oxygen conducting channels including a common oxygen outlet channel (7b) and a multitude of intermediate oxygen channels (8b) from each anode (3b) to the common oxygen outlet channel (7b).

18. A Polymer Electrolyte Membrane (PEM) electrolyzer for splitting water into hydrogen and oxygen, said electrolyzer comprising a stack of electrolysis cells (9), the cells comprising:
cathodes (3a),
anodes (3b),
membranes (2) separating the cathodes from the anodes,
bi-polar plates (6, 19) supporting the cathodes and anodes,
insulating gaskets (10) separating the cells,
a source of electric power supplying the stack,
one or more channels supplying deionized water to the cathodes and anodes,
one or more channels conducting hydrogen from the cathodes and oxygen from the anodes,
characterized in that
the, one or more, deionized water supplying channel(s) include first and/or second deionized water channels (4a, 4b),
a multitude of first intermediate deionized water channels (5a) conducting deionized water from the first deionized water inlet channel (4a) to each cathode (3a) in the stack,
and/or
a multitude of second intermediate deionized water channels (5b) conducting deionized water from the second deionized water inlet channel (4b) to each anode (3b) in the stack,
the, one or more, hydrogen conducting channels include a common hydrogen outlet channel (7a) a multitude of intermediate hydrogen channels (8a) conducting hydrogen from each cathode (3a) to the common hydrogen outlet channel (7a),
and/or
the, one or more, oxygen conducting channels include a common oxygen outlet channel (7b) and a multitude of intermediate oxygen channels (8b) conducting oxygen from each anode (3b) to the common oxygen outlet channel (7b).
